(19) United States
(12) Patent Application Publication
(10) Pub. No.: US 2025/0149656 A1
(43) Pub. Date: May 8, 2025

(54) BATTERY LOCK ELECTRONICS FOR RELEASING AND LOCKING A BATTERY AND METHOD THEREOF

(71) Applicant: ME SOLSHARE INTERNATIONAL PTE. LTD., Singapore (SG)

(72) Inventors: Hannes KIRCHHOFF, Singapore (SG); Syed Ishtiaque AHMED, Singapore (SG)

(21) Appl. No.: 18/835,742

(22) PCT Filed: Feb. 3, 2023
(86) PCT No.: PCT/IB2023/050961

§ 371 Date: Aug. 5, 2024

(30) Foreign Application Priority Data
Feb. 7, 2022 (DE) 10 2022 102 785.6

(51) Int. Cl. H01M 10/42; H02J 7/00

(52) U.S. Cl. CPC H01M 10/425; H02J 7/00302; H02J 7/00306; H02J 7/0031; H01M 2010/4271

(57) ABSTRACT

The present invention relates to battery lock electronics (1) for a battery unit (4) having a battery management system (3), the battery lock electronics (1) having:
a) a first electronic interface (1a) with a battery management system (3),
b) a second electronic interface (1b) with a communication device (2) and
c) a processor unit (1c) connected to the first (1a) and to the second interface (1b),
and performing, upon detection of an unlock signal via the second interface (1b):
   reading out of a battery state-of-charge value (7) from the battery management system (3),
   storing an upper threshold value (8) in the battery management system (3),
   storing a lower threshold value (9) in the battery management system (3), and
   determining from the battery state-of-charge value (7):
   the upper threshold value (8) which is determined to be greater than the battery state-of-charge value (7) by a predetermined upper value;
   the lower threshold value (9) which is determined to be lower than the battery state-of-charge value (7) by a predetermined lower value.

The present invention relates to battery locking electronics for releasing and locking a battery and a corresponding method therefor.

In vehicles, and in particular in small electric vehicles, it may not be necessary for the entire vehicle having at least one battery to be connected to a charging station, but the battery may be removed and replaced. In this case, it may be useful to equip the battery with an anti-theft device so that it cannot simply be stolen and then used in another vehicle. Preferably, the battery is understood as a battery unit which is preferably relatively easy to install, remove and replace, and which may preferably comprise one or more battery cells. In this context, several batteries can also be installed in the vehicle and preferably connected in parallel.

WO2004074042 A2 discloses a method for this purpose, for example, in which the battery has an internal high-current switch that can be closed or opened by radio. Through the high-current switch, the battery can be switched as a power supply with only a low allowable current and a power supply with a high allowable current. For example, a power supply of a vehicle electronic system can continue to operate while a starter motor, which has a high current demand, is not sufficiently supplied.

A similar method is disclosed in document WO9641734 A1, in which the battery provided therein likewise has the high-current switch for disconnecting one of its power supply poles led to the outside, with a receiving electronics receiving an external signal and converting it to control the high-current switch and hold it with a timer electronics.

DE 102012212269 A1 discloses a secured battery which also has the internal high-current switch, the activation of which communicates with an immobilizer, the battery also limiting or blocking an output current in the event of a blocking state.

Modern and in particular Li-ion based batteries have internally or as interconnected elements between the battery and a consumer or a charging terminal a corresponding battery management system, which can disconnect the battery from a charging and/or current draw terminal. This can prevent both erroneous overcharging and erroneous deep discharging of the battery, each of which would damage the battery. Preferably, all battery cells of the battery are monitored individually and/or the entire battery is monitored via its battery poles and its total battery voltage, the battery current is monitored and the temperature is monitored at one or more points. Preferably, one of the respective battery poles minus or plus is interrupted by the internal high-current switch of the battery management system. In this context, the high-current switch may be a relay or one or a composite of semiconductor switches. Some of such batteries have a readout and programming interface through which battery state parameters can be read and/or a respective battery management program and respective minimum and maximum voltages for the respective battery cell and/or a total battery voltage can be programmed. Some such batteries can be switched on and off via Bluetooth wireless technology and a corresponding application on a smartphone. Changes to the battery management system must be extensively tested to avoid a malfunction, which can have fatal consequences. Validation in this context is often very complex and costly.

The known procedures, as stated above, require special batteries, which must be equipped accordingly with the high-current switch and suitable electronics. Thus, vehicles with batteries having a different form factor in turn require other special batteries with the corresponding special internals, which are costly for small quantities.

The task of the invention, in order to eliminate the disadvantages from the prior art, is therefore to provide a battery or a component thereto, with which the battery can be extended as simply, safely and inexpensively as possible to include an anti-theft device.

The above task is solved by a device according to the features of independent claim 1 and a method according to the features of independent claim 9. Further advantageous embodiments of the invention are given in the dependent claims.

According to the invention, battery lock electronics are provided for a battery unit connected to a battery management system, wherein the battery lock electronics comprise:
a) battery lock electronics a first electronic interface to a first data connection with the battery management system and a second electronic interface to a second data connection with a communication device;
b) a processor unit configured to receive an enable signal from the communication device via the second electronic interface;
wherein the processor unit is adapted to communicate with the battery management system via the first electronic interface while executing the following in response to the enable signal:
   read a battery state of charge value from the battery management system,
   store an upper threshold value in the battery management system, and/or
   store a lower threshold value in the battery management system; and
c) wherein the processor unit is adapted to determine the following from the battery state of charge value:
   the upper threshold value determined by a predetermined first calculation method to be greater than the battery state of charge value by a predetermined upper value or equal to it; and/or
   the lower threshold value determined by a predetermined second calculation method to be less than the battery state of charge value by a predetermined lower value or equal to it,
   wherein the upper threshold value and/or the lower threshold value track the battery state of charge value by a differential value.

Effectively, by changing the upper threshold value in the battery management system, the charge bandwidth can be pre-determined to be strongly limited to a desired energy value. Similarly, by changing the lower threshold value in the battery management system, the energy extraction can be strongly limited to a desired energy value from the battery unit in a predetermined manner.

The advantages achieved with the invention are that in any application, such as a vehicle, the battery unit present therein, which is coupled to the battery management system, can be easily extended to include an anti-theft device without having to modify the battery unit or the battery management system in terms of software. This mainly concerns Li-ion-based battery units, which can be, for instance, permanently connected to the battery management system, such as welded, bonded, screwed or soldered. The respective battery management system already has an internal automatic shutdown mechanism against overvoltage above the upper threshold or undervoltage below the lower threshold in relation to the connected battery unit. The first electronic interface is provided and available for a connection of a diagnostic device, via which a corresponding software and corresponding parameters for the connected battery unit can be programmed and status data of the battery unit and/or the battery management system can be read out. Typically, the first electronic interface is a wired interface, such as a UART interface, an RS232, an RS485, an I2C, a CAN, or a USB interface, to which the battery lock electronics can be connected. All safety-relevant program sections and settings in the battery management system remain unchanged and therefore do not have to be validated again at great expense. With the battery blocking electronics, it is only necessary to ensure that an original upper maximum threshold value and an original lower minimum threshold value, as they may have been originally read out from the battery management system, are not exceeded or fallen short of in order not to damage the battery unit or even put it into a flammable state. If the battery lock electronics are disconnected when the battery unit is stolen, for example, the battery can only be used in the small band range between the upper and lower threshold values for a correspondingly short period of time, which is pointless for practical use.

An embodiment of the battery lock electronics, for example, as electronics that can be easily plugged into the battery unit on the battery management system is conceivably simple, and the overall cost associated with this is very low.

Preferably, the electronic first interface is a wired interface, such as the USB interface, but it can also be designed as a radio interface, such as a Bluetooth or WIFI or mobile communications interface.

Preferably, the electronic second interface is a radio interface to, for example, a smartphone as the communication device. In this case, the communication device transmits the enable signal to the battery lock electronics, for example, only if a predetermined code has been entered into the communication device or an enable has been given by a server system. An Internet connection or other data connection can exist between the server system and the communication device, for example. For example, the server system can have a server comprising a computing unit, a data connection to the communication device, and a software application that communicates with the communication device. The software application preferably comprises a payment system. Numerous systems that are known or have been or are still being developed for this purpose can be considered as payment systems. Blockchain systems are also conceivable for being connected thereto.

The second interface can also be a mobile communications interface, for example, to the server system, for example, via an Internet connection or other data connection. The second interface may be a Bluetooth interface to the smartphone or cell phone or to a Bluetooth hub connected to the Internet. Alternatively or additionally, the second interface may be a keypad or other manual input system that allows an operator to enter a code or unlock code, for example similar to a credit card for unlocking, where if the code is correct, the unlock signal is generated. The communication device may also be the keypad that communicates with the battery lock electronics via the second data link.

Preferably, the battery lock electronics also comprise the server with the software application, which communicates with the communication device (2) via an Internet or other data connection and sends the unlock signal to the processor unit (1c) via the second electronic interface (1b). For clarity, it is both conceivable that the server sends the unlock signal to the battery lock electronics directly or via the communication device, and that the server generates the unlock signal by a code or data flow in the communication device that is transmitted to battery lock electronics. For clarity, the server system is preferably a data server with a corresponding software application that can generate or initiate the unlock signal after validation of payment flows or other business logic and that can terminate an unlock period.

Preferably, the unlock period is determined by the processing unit in response to the unlock signal, with the steps of storing the upper threshold and lower threshold occurring only during the unlock period. Preferably, the processor unit considers a code transmitted by the communication device when determining the unlock period. Preferably, the unlock period is a predetermined period of time. Preferably, the unlock period runs until a read battery state of charge value deviates from a previously stored battery state of charge value by more than a predetermined value during the unlock signal. Other possibilities of determining and combinations of the above determination methods for the unlock period are also conceivable.

Preferably, the battery lock electronics has a lockout state that becomes active each time after the respective unlock period has expired. The unlock period is reactivated by the release signal in each case. Preferably, the unlock period is determined by a time clock/timer. Preferably, the unlock period may also be determined by a code and/or a timer associated therewith. Preferably, the unlock period is determined by a time clock, wherein the communication device repetitively transmits the unlock signal and reactivates the time clock each time anew.

In accordance with the application, the server system and its software application allow and/or block use of the battery by sending the unlock signal to the battery lock electronics if sending of the unlock signal fails to occur. Preferably, the unlock period can also be immediately disabled by sending of a disable signal by the server or by the communication device. A payment system may be connected to the server system and/or the communication device, through which the battery may be locked or unlocked.

Preferably, in the locked state, the upper threshold value is determined to be less than or equal to the battery state of charge value, and it is so transmitted to the battery management system. Preferably, in the locked state, the lower threshold value is determined to be greater than or equal to the battery state of charge value, and it is so transmitted to the battery management system.

Preferably, by the first calculation method, the upper threshold value is determined to be greater than the battery state of charge value by the predetermined upper value only as long as the upper threshold value is not greater than the original maximum threshold value that is just acceptable for the battery.

Preferably, the second calculation method determines the lower threshold value to be below the battery state of charge value by the predetermined lower value only as long as the lower threshold value is not below the original minimum threshold value that is just acceptable for the battery.

The upper threshold value preferably corresponds to a battery voltage of the battery unit at a charge, above which the battery management system switches off further power supply. In this context, the battery voltage and the upper threshold value preferably refer to a single battery cell, although the battery voltage and the upper threshold value can also refer to several or all battery cells of the battery unit, which are connected in parallel or in series, for example. In the case of battery cells connected in series, there is a risk that one or more cells may be overcharged or undercharged in the process. Therefore, a parallel connection is preferable, or if possible all battery cells are checked against a respective upper threshold value.

Alternatively, the lower threshold value can be determined with reference to a battery charging capacity above which the battery management system switches off further power supply.

The lower threshold value preferably corresponds to a minimum voltage of the battery unit, above which the battery management system switches off a further current draw. In this context, the battery voltage and the lower threshold value preferably refer to a single battery cell, although the battery voltage and the lower threshold value can also refer to several or all battery cells of the battery unit, which are connected in parallel or in series, for example. In the case of battery cells connected in series, there is a risk that one or more cells may be undercharged in the process. Therefore, a parallel connection is preferable, or if possible all battery cells are checked against a respective upper threshold value.

Alternatively, the lower threshold value can be determined with reference to a battery charging capacity above which the battery management system interrupts further current draw.

Preferably, the lower threshold value is determined such that a predetermined amount of energy can just be drawn from the battery with respect to the battery state of charge value. In other words, the lower threshold value is determined to represent, with respect to the battery state of charge value, a battery state of charge that lies below the battery state of charge value by the predetermined amount of energy.

Preferably, the original maximum threshold value and the original minimum threshold value are read by the processor unit and stored in the battery lock electronics when the battery lock electronics are first connected to the battery management system.

Preferably, the battery state of charge value is a battery voltage value that lies preferably between an allowable minimum voltage and a maximum voltage for the battery unit. Preferably, the upper threshold value is determined to represent a battery maximum charge voltage for the battery management system, above which the battery management system disconnects or at least reduces a power connection between the battery and a power charging station by 80% or more to avoid overcharging and damaging the battery. Preferably, the lower threshold value is selected to represent for the battery management system a battery minimum voltage below which the battery management system disconnects or at least reduces by 80% or more a power connection between the battery and a load in order not to deep discharge and damage the battery.

The lower threshold value preferably corresponds to the battery voltage of the battery unit or one or more battery cells that are completely discharged or preferably still contain a predetermined energy reserve of, for example, 20% of the fully charged battery unit. The predetermined battery reserve can also be, for example, 5%, 10%, 15%, or more or less than 20% of the fully charged battery unit. In this case, the battery voltage and the lower threshold value can refer to a single battery cell or to several battery cells of the battery unit, which are preferably interconnected in parallel.

Preferably, one or more of the following parameters are taken into account when measuring the battery voltage and determining the upper and lower threshold values: an ambient temperature, a battery temperature, an age of the battery, a current state-of-charge (SOC), a current state-of-function (SoF), a current state-of-health (SOH), an internal resistance of the battery unit, and/or an internal resistance of conductors and contacts.

Preferably, the battery unit comprises the battery management system, which together form a single unit and are preferably encapsulated. Alternatively, the battery unit and the battery management system may be arranged separately, but they are at least electrically connected to each other. The connection can be a plug-in connection or a permanently screwed connection, for example via a cable.

For clarity, the battery unit comprises one or more battery cells, each of which is preferably checked individually by the battery management system against the respective upper and lower threshold values. It is also conceivable that only a serial battery total voltage is checked as battery voltage against the upper and lower thresholds, but in doing so, it could not be ensured that individual battery cells are not overcharged or undercharged thereby.

For clarity, battery voltage is preferably understood to mean battery cell voltage or the voltage of battery cells connected in parallel.

The battery unit comprises a battery cell or an array of battery cells connected in parallel. Alternatively, the battery unit may also comprise serially connected battery cells, in which case it is preferable to ensure that, as far as possible, all sub-battery voltages are monitored using a respective upper and lower threshold value.

The battery unit preferably comprises Li-ion, LiFePo, Li-polymer battery cells or other battery cells based on a use of lithium. However, other battery cells are equally conceivable to be used in the battery unit.

Preferably, a type of battery unit and its characteristics that are important for determining the upper and lower threshold values are queried by the processor unit at the battery management system, stored and taken into account when determining the upper and lower threshold values.

A method according to the invention for locking and unlocking the battery unit with the battery management system by the battery lock electronics communicating with the battery management system and controlled by the external communication device comprises the following steps, which are automatically repetitively executed by the battery lock electronics:
a) receiving data from the communication device, if any;
b) upon detection of the unlock signal in the data:
   activating the unlock period;
c) if the unlock period is activated: automatic execution of the following steps d)-h), and otherwise, if the unlock period is not activated: return to step a);
d) reading the battery state of charge value from the battery management system and storing it in the battery lock electronics;
e) determining the upper threshold value according to the first calculation method in dependence on the battery state of charge value, wherein the upper threshold value is determined to be greater than the battery state of charge value by the predetermined upper value or equal to it, and is adjusted by the differential value to the battery state of charge value; and/or
   determining the lower threshold value according to the second calculation method in dependence on the battery state of charge value, wherein the lower threshold value is determined to be lower than the battery state of charge value by the predetermined lower value and is adjusted by the differential value to the battery state of charge value;
f) transmitting the upper threshold value and/or the lower threshold value to the battery management system for storage therein;
g) determining whether the unlock period is still active or has expired, and if the unlock period has expired: deactivating the same; and
(h) returning to step (a).

The inventive method is not intended to be limited exactly to the sequence shown above, although it is clear to those skilled in the art that other loops and queries, for example to check the unlock period for activity, are also possible.

The advantages of the method described above, analogous to the advantages of the battery lock electronics described above, lie in particular in the fact that the battery lock electronics can be constructed simply and inexpensively. In particular, the shutdown mechanisms already implemented in the battery management system are used for a utilization and charging of the battery unit, whereby only a repetitive tracking of the upper and lower threshold values in the battery management system needs to be performed by the battery lock electronics.

Preferably, by repetitively activating the unlock period up to a predetermined maximum interval length, the unlock period is permanently reactivated and remains active.

Preferably, upon receiving the lock signal from the communication device, the unlock period is immediately deactivated and the transmissions and storages of the upper threshold and the lower threshold are stopped.

Determining of whether the unlock period is still active or has expired is preferably performed in such a way that a time clock with a predetermined set time period is interrogated as to whether or not it has expired yet, whereby if the time clock has not stopped running the unlock period still remains active and if the time clock has stopped running the unlock period is deactivated. Synonymous with a time clock is a timer, where the time clock can be analog or digital, online or offline. Criteria other than the time period may also be considered for determining whether the unlock period is still active or has expired. Such criteria include, for example, a certain usage behavior of the battery and/or a detection of unusual events, a battery voltage and/or a detection of a removal of a transponder or key.

Preferably, when the lock signal is received by the communication device, the unlock period is deactivated immediately or after a predetermined time.

Preferably, upon receiving the lock signal from the communication device, the upper threshold value is set to be by a predetermined other upper value greater than or equal to the battery state of charge value and is transmitted to the battery management system and/or, preferably, the lower threshold value is set to be by a predetermined other lower value less than or equal to the battery state of charge value and is transmitted to the battery management system. Preferably, the other upper value is lower than the upper value, or in other words, the other upper value makes the difference between the upper threshold value and the battery state of charge value smaller than the difference between the upper threshold value and the battery state of charge value for the upper value. Preferably, the other lower value is lower than the lower value, so that the other lower value makes the difference between the lower threshold value and the battery state of charge value lower than the lower value.

Preferably, the upper threshold value corresponds to a maximum allowable battery voltage for the battery management system, above which the battery management system disconnects or at least reduces by 80% the power connection between the battery unit and a power charging station to avoid overcharging and damaging the battery.

Preferably, the lower threshold corresponds to a battery minimum voltage below which the battery management system disconnects or at least reduces by 80% a power connection between the battery unit and the load in order not to deep discharge and damage the battery unit.

Preferably, the unlock period is repetitively re-determined depending on one or more parameters, which may be the following: a time, the battery voltage, the upper threshold, the lower threshold, the unlock signal, the lock signal, a deviation of the current battery signal from a previously stored battery signal, a vehicle signal sent directly or indirectly to and received by the battery lock electronics from a vehicle in which the battery unit is located.

Preferred embodiments according to the present invention are shown in subsequent drawings and in a detailed description, but they are not intended to limit the present invention exclusively thereto.

In the figures:

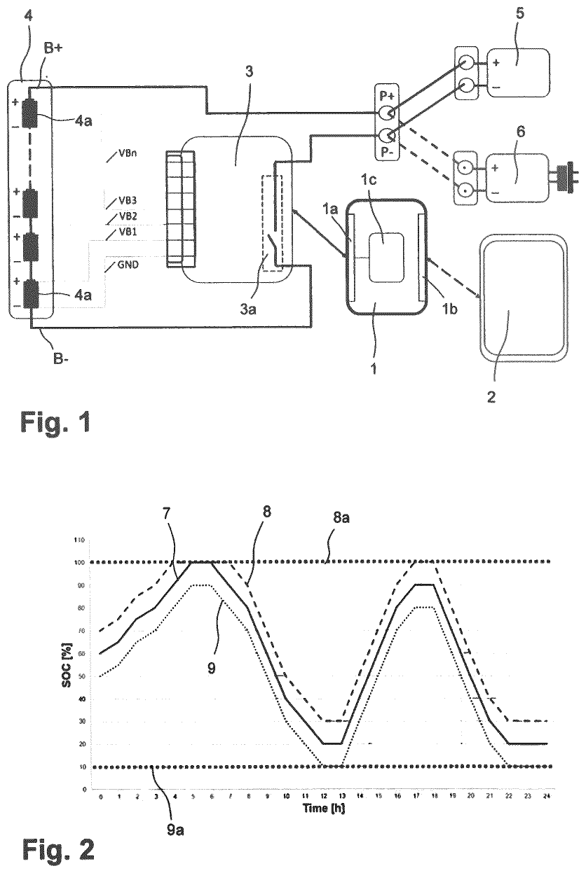

FIG. 1 shows a schematic diagram of a battery unit having a battery and a battery management system connected thereto, wherein a battery current of one pole of the battery is passed through the battery management system which can connect or disconnect the current line by means of an internal high-current switch to an external power connection, wherein a battery lock electronics is connected to the battery management system which in turn is connected to a communication device;

FIG. 2 shows a plot of a battery state of charge value between an upper threshold value and a lower threshold value over time; and

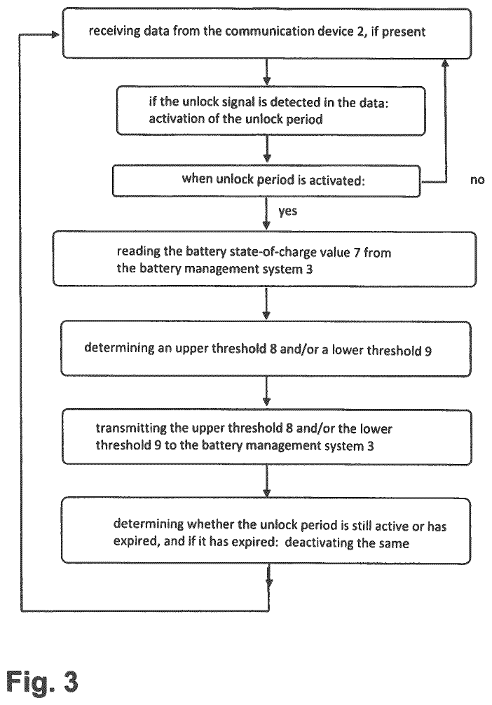

FIG. 3 shows a process flow diagram for a communication between the battery lock electronics and the battery unit.

### DETAILED DESCRIPTION OF EMBODIMENTS

FIG. 1 shows a preferred embodiment of battery lock electronics 1 for a battery unit 4 connected to a battery management system 3.

In this context, the battery lock electronics 1 has the following features according to the invention:
a) a first electronic interface 1a for a first data connection to the battery management system 3 and a second electronic interface 1b for a second data connection to a communication device 2;
b) a processor unit 1c adapted to receive an unlock signal from the communication device 2 via the second electronic interface 1b;
c) wherein the processor unit 1c is adapted to communicate with the battery management system 3 via the first electronic interface 1a and to execute the following in response to the unlock signal:
   read out a battery state of charge value 7 from the battery management system 3,
   store an upper threshold value 8 in the battery management system 3, and/or
   store a lower threshold value 9 in the battery management system 3; and
d) wherein the processor unit 1c is further adapted to determine the following from the battery state of charge value 7:
   the upper threshold value 8 determined by a predetermined first calculation method to be by a predetermined upper value greater than or equal to the battery state of charge value 7; and/or
   the lower threshold value 9 determined by a predetermined second calculation method to be by a predetermined lower value less than or equal to the battery state of charge value 7,
   wherein the upper threshold value 8 and/or the lower threshold value 9 track the battery state of charge value by a differential value.

Preferably, the battery unit 4 comprises a plurality of battery cells 4a connected in series to form a total battery voltage between, for example, a positive battery terminal B+ and a negative battery terminal B−. The total battery voltage is conducted via the battery management system 3 to a positive battery terminal P+ and a negative battery terminal P−, to which a load 5 or an energy charging station 6 can be connected. In this context, the battery management system 3 preferably has a high-current switch 3a internally, which can switch through or block the current of the battery unit 4. The consumer 5 can be, for example, one or more electric motors and vehicle electronics.

Preferably, battery voltages of all battery cells 4a are fed to the battery management system 3, and accordingly each individual battery cell 4a is monitored for the upper threshold value 8 and the lower threshold value 9. This relates, as shown schematically in FIG. 1, to the first battery voltage VB1 of the first battery cell 4a, the second battery voltage VB2 of the second battery cell 4a, the third battery voltage VB3 of the third battery cell 4a, and the nth battery voltage VBn of the nth battery cell 4a, in each case against its associated negative terminal. Thereby, the respective upper and lower threshold values may differ from each other or be the same, depending on the embodiment of the battery management system 3.

Preferably, the battery state of charge value 7 is a respective battery voltage or battery cell voltage or the total battery voltage. Alternatively, a battery state of charge value can be determined from the respective battery voltage, the battery cell voltage or the total battery voltage, which battery state of charge value can lie for example between a lower energy value and a maximum energy value. In this context, a respective energy value may also be expressed as a percentage, such as between 20% and 100% or between 0.20 and 1.00. Other units are also conceivable.

The battery management system 3, which is known from the prior art, monitors the battery state-of-charge value 7 for the associated upper threshold value 8 and lower threshold value 9. If the battery state-of-charge value 7 is greater than or equal to the associated upper threshold value 8 or less than or equal to the associated lower threshold value 9, the battery management system 3 opens its high-current switch 3a in order to interrupt or at least greatly reduce the current flow.

Thus, by the idea according to the invention of tracking the upper 8 and lower threshold values 9 around the battery state of charge value 7 with a small tolerance range, as shown for example in FIG. 2, the battery unit 4 can be secured against theft in that for it the upper 8 and lower threshold values 9 must constantly track a changing battery state of charge value 7. For example, if the battery unit 4 is discharged by the load 5, the battery state-of-charge value 7 drops below the lower threshold value 9 previously transmitted to the battery management system 3 in a corresponding short time, and the battery management system 3 shuts down the battery unit 4 by opening the high-current switch 3a. Unplugging the battery lock electronics 1 is of no use here; without the battery lock electronics 1 only a predetermined small amount of energy is still available from the battery unit 4.

Depending on the type and unit of the battery state of charge value 7, the upper 8 and lower threshold values 9 are also preferably determined. For example, the upper threshold value 8 can preferably be a battery voltage of the battery cell 4a or the battery unit 4, above which the battery management system 3 switches off a further power supply. Here, the battery voltage and the upper threshold value preferably refer to a single battery cell 4a, although the battery voltage and the upper threshold value 8 may also refer to several or all battery cells 4a of the battery unit 4, which are connected in parallel or in series, for example. In the case of battery cells 4a connected in series, there is a risk that one or more battery cells 4a may be overcharged or undercharged in the process. Ideally, all battery cells are checked against a respective upper threshold 8 and a lower threshold 9.

FIG. 2 shows an exemplary diagram over time showing charging and discharging of the battery unit 4 or a battery cell 4a based on an energy capacity value, where the corresponding battery state-of-charge value 7 can fluctuate accordingly between 20% and 100%, rising during charging and falling during discharging. The upper threshold value 8 also corresponds to a respective energy capacity value, which in this example is 10% greater than the battery state-of-charge value 7. Preferably the upper threshold value 8 is also limited upwards to the maximum 100% charge capacity value that is permissible for the battery unit 4 or the battery cell 4a. The lower threshold value 9 is represented as a lower charge capacity value curve corresponding thereto, which is in each case 10% lower than the respective associated battery capacity value or battery state-of-charge value 7. The lower threshold value 9 can also be limited downwards to a minimum capacity value.

In the battery lock electronics 1, it is preferably to be ensured that an original upper maximum threshold value 8b and an original lower minimum threshold value 9a, as may have been originally read out from the battery management system 3, are not exceeded by the upper threshold value 8 and preferably the lower threshold value 9 does not lie below it, so as not to damage the battery unit 4 or even put it into a flammable state.

Usually, the first interface 1a is an interface adapted to the battery management system 3. Intermediate interface converters between the first interface 1a and the battery management system 3 are also conceivable.

The electronic second interface 1b with the communication device 2 is preferably a radio interface, such as a Bluetooth, an NFC, a WIFI, or a mobile communications interface. For example, the second interface 1b may also be formed compatible with a Bluetooth hub. Alternatively, the electronic second interface 1b may include a keypad that a human uses to enter a code displayed by the communication device 2.

The processor unit 1c of the battery lock electronics 1 may be a microcontroller or other processor unit with memory, as known in the prior art.

The communication device 2 is preferably a cell phone or smartphone. Alternatively, the communication device 2 can also be a mobile communications station with which the battery lock electronics 1 communicate. At the end of the communication chain there is preferably a server or server system with a corresponding software application, which preferably comprises a payment system. The payment system can then be used to generate or block the lock signal and/or an unlock signal for the battery lock electronics 1.

The unlock signal preferably generates or activates an unlock period in the battery lock electronics 1, during which the battery state-of-charge value 7 is read out from the battery management system 3 by the processor unit 1c, the upper threshold value 8 and the lower threshold value 9 are determined and thereupon stored in the battery management system 3.

If a lock signal is received from the communication device 2, the processor unit 1c disables the unlock period. If the unlock period is deactivated or accordingly is not present, then the upper threshold value 8 and the lower threshold value 9 are initially not further tracked to follow the battery state-of-charge value 7.

A preferred method according to the invention, corresponding to the battery lock electronics 1, for locking and unlocking the battery unit 4 with the battery management system 3 by the battery lock electronics 1 is shown in FIG. 3. In this process, the following steps are repetitively executed by the battery lock electronics 1:
a) receiving data from the communication device 2, if present;
b) upon detection of the unlock signal in the data: activating the unlock period;
c) if the unlock period is activated: automatic execution of steps d)-h); otherwise, if the unlock period is not activated: return to step a);
d) reading the battery state-of-charge value 7 from the battery management system 3 and storing it in the battery lock electronics 1;
e) determining the upper threshold value 8 according to the first calculation method in dependence on the battery state-of-charge value 7, wherein the upper threshold value 8 is determined to be greater than the battery state-of-charge value 7 by the predetermined upper value or equal to it and is adjusted to the battery state-of-charge value 7 spaced by the differential value;
   and/or
   determining the lower threshold value 9 according to the second calculation method in dependence on the battery state-of-charge value 7, wherein the lower threshold value 9 is determined to be lower than the battery state-of-charge value 7 by the predetermined lower value or equal to it and is adjusted to the battery state-of-charge value 7 spaced by the differential value;
f) transmitting the upper threshold value 8 and/or the lower threshold value 9 to the battery management system 3 for storage therein;
g) determining whether the unlock period is still active or has expired, and if the unlock period has expired: deactivating the same; and
h) returning to step a).

The advantages of the method described above, analogous to the advantages of the battery lock electronics described above, lie in particular in the fact that the battery lock electronics can be constructed simply and inexpensively. In particular, the shutdown mechanisms already implemented in the battery management system are used for utilization and charging of the battery unit, whereby only repetitive tracking of the upper and lower threshold values in the battery management system needs to be performed by the battery lock electronics.

Further embodiments of the method are already described above.

For clarity, the battery lock electronics 1 and the associated method can be embodied such that it is possible for either the upper threshold value 8 or the lower threshold value 9 to be determined and transmitted to the battery management system 3, or it is also possible for the upper threshold value 8 and the lower threshold value 9 to be determined and transmitted to the battery management system 3.

For clarity, the terms “upper” and “lower” are understood to refer to relative locations in the vertical direction, as shown for example in FIG. 3.

For purposes of clarity, it should also be noted that indefinite articles associated with an object or numerical indications, such as “one” with reference to an object, do not numerically limit the object to exactly one object, but that “at least one” object is intended.

It is understood that when an item is said to be “placed on”, “connected to”, “coupled to”, or “in contact with” another item, the item may be positioned directly on, connected to, or coupled to the other item, or that there may be intermediate items that are either merely interposed or connect or couple or keep the item in contact with the other item. On the other hand, when an item is described as being “directly on” another item, “directly connected” thereto, “directly coupled” thereto, or “directly in contact” therewith, it is to be understood that there are no intermediate elements. Similarly, when a first item is referred to as being “in electrical contact” with a second item, or “electrically coupled” thereto, an electrical pathway is present that allows current to flow between the first item and the second item. The electrical path may include capacitors, coupled inductors, and/other elements that allow current to flow even without direct contact between the conductive items.

Although the expressions “first,” “second,” etc. may be used herein to refer to various elements, components, regions and/or sections, such elements, components, regions and/or sections are not limited by such expressions. The expressions are used only to distinguish one element, component, region, or section from another element, component, region, or section. Therefore, a first element, component, region or section discussed below may be referred to as a second element, second component, second region or section without departing from the teachings of the present invention.

Embodiments of the invention are not to be construed as limited to the particular shapes of the components shown herein, but are intended to include variations of the shapes resulting, for example, from the method of manufacture. An area shown or designated as square or rectangular will typically also have rounded or curved features due to normal manufacturing tolerances. Therefore, the components shown in the figures are of a schematic nature, and their shapes are not intended to represent the exact shape of a component of a device or to limit the scope of protection of the invention.

Relational expressions, such as “inner,” “outer,” “upper,” “above,” “below,” and “under”, and similar expressions may be used to denote a relationship between one layer or other component and another layer or component. It is understood that these expressions are intended to encompass various orientations of the device in addition to the orientation shown in the figures.

Regarding the term “comprise”, it is to be said for clarity purposes that, when a first device part comprises a second device part, this means that the first device part “contains” the second device part and does not necessarily encompass the second device part unless, for example, an exact arrangement in terms of position and shape is described; the same applies to a method, which may comprise one or more method steps.

Other possible embodiments are described in the following claims. In particular, the various features of the embodiments described above may also be combined, provided that they are not mutually technically exclusive.

The reference numbers mentioned in the claims serve only to enhance comprehensibility and do not limit the claims in any way to the forms shown in the figures.

### LIST OF REFERENCE NUMBERS

1 battery lock electronics
1a first electronic interface with a first data connection
1b second electronic interface with a second data connection
1c processor unit, e. g. a microcontroller
2 communication device (e. g. smartphone, server)
3 battery management system
3a high-current switch
4 battery unit
4a battery cell
5 load, e. g. at least one electric motor
6 energy charging station
7 battery state-of-charge value in dependence on a battery voltage
8 upper threshold value
8a original upper maximum threshold value
9 lower threshold value
9a original lower minimum threshold value
B+ positive battery terminal
B− negative battery terminal
P+ positive battery terminal
P− negative battery terminal
GND ground or ground potential
SOC state of charge in percent
VB1 first battery voltage of first battery cell
VB2 second battery voltage of second battery cell
VB3 third battery voltage of third battery cell
VBn n^{th} battery voltage of n^{th} battery cell

1. Battery lock electronics for a battery unit having a battery management system, the battery lock electronics having
a) a first electronic interface with a first data connection to the battery management system and a second electronic interface with a second data connection to a communication device;
b) a processor unit adapted to receive an unlock signal from the communication device via the second electronic interface;
c) the processor unit being adapted to communicate with the battery management system via the first electronic interface and to perform the following upon the unlock signal:
reading out a battery state-of-charge value from the battery management system,
storing an upper threshold value in the battery management system and/or
storing a lower threshold value in the battery management system; and
d) the processor unit being adapted to determine the following from the battery state-of-charge value:
the upper threshold value which is determined according to a first predefined calculation method to be greater than the battery state-of-charge value by a predetermined upper value or equal to it; and/or
the lower threshold value which is determined according to a second predefined calculation method to be lower than the battery state-of-charge value by a predetermined lower value or equal to it;
wherein the upper threshold value and/or the lower threshold value is adjusted to the battery state-of-charge value spaced by a differential value.

2. The battery lock electronics according to claim 1, the second electronic interface being a radio interface with a smartphone as the communication device, a mobile communications interface with an Internet connection or a Bluetooth interface with a cell phone or a Bluetooth hub which is connected to the Internet.

3. The battery lock electronics according to claim 1, comprising a server which communicates with the communication device via an Internet or other data connection and sends the unlock signal to the processor unit via the second electronic interface.

4. The battery lock electronics according to claim 1, where the processor unit determines an unlock period upon the unlock signal and where the steps of storing the upper threshold value and the lower threshold value only take place during the unlock period.

5. The battery lock electronics according to claim 4, wherein the processor unit takes into account a code transmitted by the communication device when the unlock period is determined; and/or
where the unlock period is a predetermined time span; or
where the unlock period runs until a read battery state-of-charge value deviates from a previously stored battery state-of-charge value by more than a predetermined value during the unlock signal.

6. The battery lock electronics according to claim 1, where by the first calculation method, the upper threshold value is determined to be greater than the battery state-of-charge value by the predetermined upper value only as long as the upper threshold value is not greater than a predetermined original maximum threshold value that is just acceptable for the battery; and/or
where by the second calculation method, the lower threshold value is determined to be lower than the battery state-of-charge value by the predetermined lower value only as long as the lower threshold value is not lower than a predetermined original minimum threshold value that is just acceptable for the battery.

7. The battery lock electronics according to claim 6, where the original maximum threshold value and the original minimum threshold value are read out by the processor unit at a first connection of the battery lock electronics with the battery management system of the processor unit and stored into the battery lock electronics.

8. The battery lock electronics according to claim 1, the battery state-of-charge value being a battery voltage value and/or
the upper threshold value being determined to represent a battery maximum charge voltage for the battery management system, above which the battery management system disconnects or at least reduces a power connection between the battery and a power charging station by 80% to avoid overcharging and damaging the battery; and/or
the lower threshold value being determined to represent a battery minimum voltage for the battery management system below which the battery management system disconnects or at least reduces by 80% a power connection between the battery and a load in order not to deep discharge and damage the battery.

9. Method of locking and unlocking a battery unit with a battery management system by a battery lock electronics communicating with the battery management system and controlled by an external communication device, the following steps being automatically repetitively executed by the battery lock electronics:
a) receiving data from the communication device, if present;
b) upon detection of the unlock signal in the data: activating an unlock period;
c) if the unlock period is activated: automatic execution of steps d)-h); otherwise, if the unlock period is not activated: return to step a);
d) reading a battery state-of-charge value from the battery management system and storing it in the battery lock electronics;
e) determining an upper threshold value according to a first calculation method in dependence on the battery state-of-charge value, wherein the upper threshold value is determined to be greater than the battery state-of-charge value by a predetermined upper value or equal to it and is adjusted to the battery state-of-charge value spaced by a differential value;
and/or
determining a lower threshold value according to a second calculation method in dependence on the battery state-of-charge value, wherein the lower threshold value is determined to be lower than the battery state-of-charge value by a predetermined lower value or equal to it and is adjusted to the battery state-of-charge value spaced by a differential value;
f) transmitting the upper threshold value and/or the lower threshold value to the battery management system for storage therein;
g) determining whether the unlock period is still active or has expired, and if the unlock period has expired: deactivating the same; and
h) returning to step a).

10. The method of locking and unlocking the battery unit according to claim 9, where determining of whether the unlock period is still active or has expired is performed in such a way that a time clock with a predetermined time period is interrogated as to whether or not it has expired yet, whereby if the time clock has not stopped running the unlock period still remains active; and/or
where repetitively activating the unlock period up to a predetermined maximum interval length keeps the unlock period permanently activated; and/or
where determining whether the unlock period is still active or has expired is performed in such a way that a detection of a lock signal from the communication device deactivates the unlock period immediately or after a predetermined time; and/or
where upon receiving the lock signal from the communication device, the upper threshold value is set to be greater by a predetermined other upper value than the battery state-of-charge value or equal to it and is transferred to the battery management system and/or the lower threshold value is set to be lower by a predetermined other lower value than the battery state-of-charge value or equal to it and is transferred to the battery management system.

11. The method of locking and unlocking the battery unit according to claim 9, where the battery state-of-charge value corresponds to a battery voltage; and/or
where the upper threshold value corresponds to a maximum allowable battery voltage above which the battery management system disconnects or at least reduces a power connection between the battery unit and a power charging station by 80% to avoid overcharging and damaging the battery; and/or
where the lower threshold value corresponds to a battery minimum voltage below which the battery management system disconnects or at least reduces by 80% a power connection between the battery unit and a load in order not to deep discharge and damage the battery unit.
